(19) United States
(12) Patent Application Publication
(10) Pub. No.: US 2025/0368808 A1
(43) Pub. Date: Dec. 4, 2025

(54) RUBBER BLENDS CONTAINING AT LEAST ONE FUNCTIONALIZED SYNTHETIC RUBBER AND AT LEAST ONE ETHOXYLATED ALCOHOL

(71) Applicant: LANXESS Deutschland GmbH, Cologne (DE)

(72) Inventors: Antonia Albers, Cologne (DE); Cristian Oprisoni, Oftersheim (DE); Torsten Ziser, Birkenau (DE); Hermann-Josef Weidenhaupt, Pulheim (DE)

(73) Assignee: LANXESS Deutschland GmbH, Cologne (DE)

(21) Appl. No.: 18/876,008

(22) PCT Filed: Jun. 16, 2023
(86) PCT No.: PCT/EP2023/066290

§ 371 Date: Dec. 17, 2024

(30) Foreign Application Priority Data
Jun. 23, 2022 (EP) 22180723.3
Feb. 16, 2023 (EP) 23156954.2

(51) Int. Cl. C08L 9/00; C08K 3/011; C08K 3/22; C08K 3/34; C08K 5/05; C08K 5/36; C08K 5/548; C08L 7/00

(52) U.S. Cl. CPC C08L 9/00; C08K 3/011; C08K 3/22; C08K 3/34; C08K 5/05; C08K 5/36; C08K 5/548; C08L 7/00; C08K 2003/2296

(57) ABSTRACT

The invention relates to rubber mixtures containing, in addition to fillers and crosslinkers, 50 to 100 phr of at least one functionalized synthetic rubber and 0.5 to 20 phr of the at least one ethoxylated compound of formula (I) RO(CH₂CH₂O)ₓH (I), wherein R represents alkyl, wherein alkyl may be branched or unbranched, and x represents a rational number from 1 to 25, suitable for producing vulcanizates having a low rolling resistance.

The invention relates to novel rubber mixtures containing at least one functionalized synthetic rubber and at least one ethoxylated compound of formula (I), to processes for the production thereof, to the use thereof for producing rubber vulcanizates, to the corresponding vulcanizates and to the use of the at least one functionalized synthetic rubber and the at least one ethoxylated compound of formula (I) in rubber mixtures, vulcanizates and shaped articles obtainable therefrom for reducing the rolling resistance of shaped articles containing these vulcanizates, preferably of tires.

The EU is obligated to reduce its greenhouse gas emissions to achieve climate neutrality by 2050. Reducing CO2 emissions from road traffic plays a major role in achieving these targets.

A new EU tire labeling system, which entered into force on May 1, 2021, is based on three important tire characteristics: Rolling resistance—and thus fuel efficiency—, wet grip and external rolling noise. The new EU tire label will allow consumers to actively choose more fuel-efficient tires.

More fuel-efficient tires contribute to reducing emissions in road traffic. Depending on the rolling resistance of the tire, fuel efficiency ranges from Class A (best fuel efficiency) to Class E. Fuel consumption is important from both economic and environmental standpoints. Low fuel consumption has a positive effect on the CO2 balance of the vehicle, especially for heavy commercial vehicles.

Against this backdrop, tire manufacturers are looking for economic ways to achieve the Class A fuel efficiency target for tires.

The use of silica-containing rubber mixtures for the production of passenger car tire treads is known. The silica contributes to a good combination of properties comprising rolling resistance, wet grip and abrasion as are required for passenger car tire treads. To achieve the desired combination of properties the silica must be efficiently dispersed in the rubber mixture and optimally coupled to the rubber matrix in the vulcanization.

To improve the processability of silica-containing rubber mixtures it is possible to employ further additives such as for example fatty acid esters, fatty acid salts or mineral oils. The aforementioned additives have the disadvantage that they increase flowability but simultaneously reduce stress values at higher elongation (e.g. 100% to 300%) or else reduce the hardness of the vulcanizates, thus adversely affecting the reinforcing effect of the filler. However, insufficient hardness or stiffness of the vulcanizate results in inadequate driving characteristics of the tire, particularly during cornering. In addition, an excessively low hardness leads to increased abrasion of the vulcanizate by the roadway and thus to an elevated proportion of so-called “micropplastics” in the environment. Tire wear particles are the main source of microplastics in rivers and lakes and make up approximately 28 percent of the plastic particles in the oceans.

The loss factor tan δ provides an important indication for assessing rolling resistance. The lower the loss factor tan δ, the lower the rolling resistance. The loss factor tan δ should be as low as possible at 60° C. to 70° C.; <0.2 according to U.S. Pat. No. 9,783,658B2 and <0.12 according to EP 2858831A2.

EP 2858831A2 discloses that rubber mixtures containing 1 phr of 1,6-bis(N,N-dibenzylthiocarbamoyldithio)hexane (CAS No: 151900-44-6) and 1 phr of certain sulfur-containing additives results in vulcanizates having good dynamic characteristics, good hardness/stiffness, good rolling resistance and low abrasion. A disadvantage is that the scorch time (t5) is significantly reduced during vulcanization of this rubber mixture, which is a major disadvantage in terms of processing reliability. From the standpoint of the rubber processing industry, it is also more advantageous to use just a few mixture components.

In U.S. Pat. No. 9,376,551A1, rolling resistance is reduced by adding certain organosilicon polysulfides. The results in table 2 of U.S. Pat. No. 9,376,551A1 show that 1 phr of the organosilicon polysulfide reduces the loss factor (tan δ at 60° C.) by more than 10 percent. The mechanical properties such as tensile strength, breaking elongation and 300 modulus remained virtually unchanged. Here too, it is a disadvantage that the scorch time is drastically reduced by addition of the organosilicon polysulfide.

It was accordingly an object of the present invention to provide improved rubber mixtures based on a hydroxyl-containing oxidic filler which overcome the aforementioned disadvantages and lead to vulcanizates and shaped articles produced therefrom such as tire treads having a low rolling resistance measured by the loss factor tan δ at 60° C., preferably at a measuring frequency of 10 Hz, coupled with unchanged or improved properties such as 300 modulus, breaking elongation and hardness. The improved rubber mixtures should preferably also have reduced complete vulcanization times (t95). The improved rubber compounds should also preferably lead to vulcanizates which have lower DIN abrasion and are thus more environmentally friendly.

A low loss factor tan δ at 60° C., preferably at a measuring frequency of 10 Hz, determined by DIN EN ISO 6721-1 dynamic damping is preferably less than 0.2, particularly preferably less than 0.12.

The scorch time t5 determined according to ASTM D5289-95 at 160° C. is preferably in the range of 70-150 seconds, particularly preferably in the range of 85-140 seconds.

A short complete vulcanization time t95 (95% conversion time) determined according to ASTM D5289-95 at a temperature of 160° C. is preferably in the range of 800-1300 seconds, particularly preferably 900-1200 seconds.

The Mooney viscosity ML 1+4 determined according to ASTM D1646 at 100° C. is preferably in a range from 30 to 100 MU, particularly preferably in the range from 50 to 90 MU.

A high 300 modulus value is also advantageous for vulcanizates, in particular for the tire treads. The 300 modulus (determined according to DIN 53504) is preferably 8-20 MPa, particularly preferably 9.5-20 MPa.

The hardness determined according to DIN53505 should preferably be in a range of 55-70 Shore A.

The DIN abrasion determined according to ASTM D5963 should preferably be low and particularly preferably less than 120 mm³, very particularly preferably less than 110 mm³.

The unit “phr” hereinbelow stands for parts by weight based on 100 parts by weight of the total amount of rubber present in the rubber mixture, i.e. the total amount of functionalized and unfunctionalized synthetic rubber(s) and natural rubber(s).

The above object is surprisingly achieved by rubber mixtures according to the invention containing
50 to 100 phr of at least one functionalized synthetic rubber, preferably of a functionalized BR rubber and/or functionalized SBR rubber,
0 to 50 phr of at least one natural rubber and/or unfunctionalized synthetic rubber,
0.1 to 250 phr of at least one hydroxyl-containing oxidic filler,
0 to 120 phr of at least one carbon black, preferably 0.1 to 100 phr,
0.1 to 20 phr of at least one crosslinker, preferably selected from the group of sulfur donors and/or sulfur,
   and
   0.5 to 20 phr of at least one ethoxylated compound of formula (I)

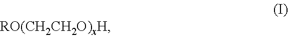

wherein
R represents alkyl, wherein alkyl may be branched or unbranched,
and
x represents a rational number from 1 to 25.

The vulcanizates according to the invention obtained by vulcanization of the rubber mixtures according to the invention surprisingly feature a low loss factor tan δ at 60° C. and an improved 300 modulus as well as a reduced Mooney viscosity, short complete vulcanization time (t95) and sufficiently long scorch time (t5) while retaining equally good performance characteristics such as breaking elongation, hardness and vulcanization characteristics.

### Rubbers

The rubber mixtures according to the invention contain at least one functionalized synthetic rubber, preferably selected from the group consisting of polar and non-polar functionalized synthetic rubbers.

Functionalized synthetic rubber in the context of the present invention is to be understood as meaning a synthetic rubber which is substituted at the main chain and/or at the end groups by one or more functional groups, preferably selected from carboxyl groups, mercaptan groups, alkoxysilane groups, siloxane groups, hydroxyl groups, ethoxy groups, epoxy groups, amino groups, phthalocyanine groups, silane-sulfide groups and metal atom-containing groups, particularly preferably selected from mercaptan groups, alkoxysilane groups and hydroxyl groups, very particularly preferably selected from mercaptan groups and alkoxysilane groups.

Preferred polar and non-polar functionalized synthetic rubbers are functionalized
BR—polybutadiene
ABR—butadiene/C1-C4-alkyl acrylate copolymer
CR—polychloroprene
IR—polyisoprene
SBR—styrene/butadiene copolymers having styrene contents of 1-60%, preferably 20-50%, by weight
HR—isobutylene/isoprene copolymers
NBR—butadiene/acrylonitrile copolymers having acrylonitrile contents of 5-60%, preferably 10-50%, by weight
HNBR—partially or fully hydrogenated NBR rubber
EPDM—ethylene/propylene/diene copolymers
SIBR—styrene-isoprene-butadiene rubber
ENR—epoxidized natural rubber
SNBR—acrylonitrile-styrene/butadiene rubber
HNBR—hydrogenated acrylonitrile/butadiene rubber
XNBR—carboxylated acrylonitrile/butadiene rubber
HXNBR—hydrogenated carboxylated arcylnitrile/butadiene rubber

The at least one functionalized synthetic rubber is preferably selected from the group consisting of functionalized SBR rubber, functionalized BR rubber and functionalized IR rubber, particularly preferably from functionalized SBR rubber and functionalized BR rubber.

It is preferable when the rubber mixtures according to the invention contain at least one functionalized SBR rubber and/or a functionalized BR rubber, particularly preferably at least one functionalized SBR rubber and at least one functionalized BR rubber.

It is preferable when the at least one functionalized SBR rubber is substituted at the main chain and/or at the end groups by one or more functional groups, in particular selected from mercaptan groups, alkoxysilane groups and hydroxy groups, particularly preferably by two or more functional groups that are mercaptan groups and alkoxysilane groups. It is preferable when the at least one functionalized SBR rubber is SPRINTAN® SLR 3402 from Trinseo.

The functionalized SBR rubber may be solution-polymerized styrene-butadiene rubber (SSBR) or emulsion-polymerized styrene-butadiene rubber (ESBR) wherein it is also possible to employ a mixture of at least one functionalized SSBR and at least one functionalized ESBR.

The molar weight (Mw) of the styrene-butadiene copolymers may be varied over a wide range. Preference is given to styrene-butadiene copolymers having an Mw of 250 000 to 600 000 g/mol, particularly preferably having a Mw of 350 000 to 500 000 g/mol.

The at least one functionalized BR rubber is preferably substituted at the main chain and/or at the end groups by one or more functional groups selected from mercaptan groups, alkoxysilane groups and hydroxy groups, particularly preferably by alkoxysilane groups. The at least one functionalized BR rubber is preferably NIPOL® BR 1261 from Zeon.

The molar weight of the butadiene polymers may be varied over a wide range. Preference is given to butadiene polymers having an Mw of 250 000 to 500 000 g/mol.

Polybutadiene having a cis content of not less than 90% by weight is referred to as high-cis and polybutadiene having a cis content of less than 90% by weight is referred to as low-cis. An example of a low-cis polybutadiene is Li—BR (lithium-catalyzed butadiene rubber) having a cis content of 20% to 50% by weight. In the context of the present invention preference is given to a high-cis functionalized BR rubber.

The rubber mixtures according to the invention contain 50 to 100 phr of at least one functionalized synthetic rubber, preferably 70-100 phr.

The rubber mixtures according to the invention preferably contain at least one functionalized SBR and at least one functionalized BR rubber in the weight ratio SBR:BR of 100:0 to 0:100, particularly preferably of 90:10 to 10:90, very particularly preferably of 90:10 to 30:70, very very particularly preferably of 80:20 to 50:50.

In addition to the aforementioned functionalized synthetic rubbers the inventive rubber mixtures may also contain at least one unfunctionalized synthetic rubber and/or at least one natural rubber. The aforementioned embodiments for the functionalized synthetic rubbers also apply, with the exception that in the case of unfunctionalized synthetic rubbers said rubbers are not functionalized.

The inventive rubber mixtures may contain 0 to 50 phr of at least one unfunctionalized synthetic rubber and/or at least one natural rubber, preferably 0-30 phr.

### Ethoxylated Compound of Formula (I)

The rubber mixtures according to the invention contain at least one ethoxylated compound of formula (I)

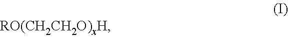

wherein
R represents alkyl, wherein alkyl may be branched or unbranched,
and
x represents a rational number from 1 to 20.

R preferably represents C₁-C₂₀-alkyl, particularly preferably C₅-C₁₇-alkyl, very particularly preferably C₁₀-C₁₅-alkyl, very very particularly preferably iso-C₁₃-alkyl, most preferably iso-C₁₃H₂₇.

x preferably represents a rational number from 2 to 22, particularly preferably from 4 to 20.

At least one ethoxylated compound of formula (I) is present for example in MARLIPAL® O 13/50 from Sasol.

The rubber mixtures according to the invention generally contain the at least one ethoxylated compound of formula (I) in an amount of 0.5 to 20.0 phr, preferably of 1.0 to 15.0 phr, particularly preferably of 2.0 to 12.0 phr and very particularly preferably of 4.0 to 11.0 phr.

### Fillers

The at least one hydroxyl-containing oxidic filler is preferably selected from the group consisting of silica, synthetic silicates and natural silicates.

The content of hydroxyl-containing oxidic fillers in the rubber mixtures according to the invention is 0.1 to 250 phr, preferably 20 to 200 phr, particularly preferably 25 to 180 phr and very particularly preferably 30 to 160 phr.

Suitable hydroxyl-containing oxidic fillers are preferably those selected from the group of
silicas, in particular having a specific surface area (BET) of 5 to 1000, preferably 20 to 400, m2/g, preferably having primary particle sizes of 100 to 400 nm, wherein the silicas may optionally also be present as mixed oxides with other metal oxides, such as Al, Mg, Ca, Ba, Zr, Ti oxides,
synthetic silicates, such as aluminum silicate, alkaline earth metal silicates such as magnesium silicate or calcium silicate, having specific surface areas (BET) of 20 to 400 m 2/g, preferably having primary particle sizes of 10 to 400 nim,
   and
natural silicates, such as kaolin and other naturally occurring silicas,
   and mixtures thereof.

The aforementioned BET surface areas are determined according to DIN ISO 9277. The indicated primary particle sizes are based on measurements using an instrument for particle analysis using scattered light. The calculation of particle size is based on Mie theory which describes the interaction between light and matter (DIN/ISO 13320).

It is preferable when the silicas are obtainable by precipitation of solutions of silicates or flame hydrolysis of silicon halides.

It is preferable when the rubber mixtures according to the invention contain at least one hydroxyl-containing oxidic filler from the group of silicas, especially having a specific surface area (BET) in the range from 5 to 1000, preferably 20 to 400, m2/g in an amount of 0.1 to 250 phr, preferably 20 to 200 phr, particularly preferably of 25 to 180 phr, very particularly preferably 30-160 phr.

The rubber mixtures according to the invention may contain at least one carbon black as filler.

In a preferred embodiment the rubber mixtures according to the invention contain at least one carbon black as filler.

The rubber mixtures of the invention preferably contain at least one carbon black in an amount of 0.1 to 120 phr, preferably 0.1 to 100 phr, particularly preferably 1 to 70 phr, very particularly preferably 2 to 40 phr.

Preference is given to carbon blacks that are obtainable by the lamp black, furnace black or gas black method and have a specific surface area (BET) in the range from 20 to 200 m²/g, for example SAF, ISAF, IISAF, HAF, FEF or GPF carbon blacks. The rubber mixtures of the invention preferably contain at least one carbon black having a specific surface area (BET) in the range from 20 to 200 m²/g.

It is preferable when the rubber mixtures according to the invention contain at least one of the aforementioned silicas and at least one of the aforementioned carbon blacks as fillers.

It is very particularly preferable when the rubber mixtures according to the invention contain 25 to 180 phr, preferably 30 to 160 phr, of at least one of the aforementioned silicas and 1.0 to 70 phr, preferably 2.0 to 40 phr, of at least one of the aforementioned carbon blacks as fillers.

The total amount of carbon black and silica-based fillers in the rubber mixture according to the invention is preferably 26 to 250 phr, particularly preferably 32 to 200 phr.

### Crosslinkers and Vulcanization Accelerators

The rubber mixtures according to the invention may contain one or more crosslinkers.

It is preferable when the rubber mixtures according to the invention contain at least one crosslinker from the group of sulfur and sulfur donors.

Sulfur may be used in elemental soluble or insoluble form. It is particularly preferable when the rubber mixtures according to the invention contain at least one sulfur donor and/or sulfur, very particularly preferably sulfur.

Examples of suitable sulfur donors include dimorpholyl disulfide (DTDM), 2-morpholinodithiobenzothiazole (MBSS), caprolactam disulfide, dipentamethylenethiuram tetrasulfide (DPTT), tetramethylthiuram disulfide (TMTD) and tetrabenzylthiuram disulfide (TBzTD).

The rubber mixtures according to the invention generally contain 0.1 to 20 phr, preferably 0.5 to 10 phr, particularly preferably from 1.0 to 8 phr and most preferably 1 to 4 phr of the at least one crosslinker from the group of sulfur and sulfur donors.

Rubber mixtures according to the invention may also contain zinc oxide. This is a complexing agent for sulfur and sulfur donors and thus simplifies the bonding of the sulfur to the rubber matrix.

Preferred rubber mixtures according to the invention contain zinc oxide having a BET surface of 2 to 100 m²/g, preferably 2 to 70 m²/g. BET surface areas of zinc oxide may be measured according to DIN ISO 9277.

Zinc oxide is generally present in the rubber mixtures according to the invention in an amount of 0 to 20 phr, preferably of 0.1 to 10 phr, particularly preferably of 1 to 5 phr.

The rubber mixtures according to the invention may contain one or more vulcanization accelerators. The rubber mixtures according to the invention preferably contain at least one vulcanization accelerator, particularly preferably from the group of mercaptobenzothiazoles, thiocarbamates, dithiocarbamates, thiurarns, thiazoles, sulfenamides, thiazolesulfenamides, xanthates, bi- or polycyclic amines, thiophosphates, dithiophosphates, caprolactams, thiourea derivatives, guanidines, cyclic disulfanes and amines, in particular zinc diaminediisocyanate, hexamethylenetetramine, 1,3-bis(citraconimidomethyl)benzene, and very particularly preferably from the group of the sulfenamides, very particularly preferably N-cyclohexylbenzothiazolesulfenamide (CAS No.: 95-33-0).

The rubber mixtures of the invention comprise generally 0.1 to 20 phr, preferably 0.5 to 10 phr and more preferably 1.0 to 5 phr of at least one of the vulcanization accelerators mentioned.

The rubber mixtures of the invention preferably contain at least one crosslinker and at least one vulcanization accelerator.

The rubber mixtures of the invention particularly preferably contain at least one crosslinker from the group of sulfur and sulfur donors and at least one vulcanization accelerator from the group of mercaptobenzothiazoles, thiazolesulfenamides, thiurams, dithiocarbamates, xanthates and thiophosphates, particularly preferably from the group of sulfenamides, very particularly preferably N-cyclohexylbenzothiazolesulfenamide (CAS No.: 95-33-0).

The rubber mixtures of the invention particularly preferably contain at least one crosslinker selected from the group consisting of sulfur and sulfur donors, at least one vulcanization accelerator selected from the group consisting of mercaptobenzothiazoles, thiazolesulfenamides, thiurams, dithiocarbamates, xanthates and thiophosphates, particularly preferably from the group of sulfenamides, very particularly preferably N-cyclohexylbenzothiazole-2-sulfenamide (CAS No.: 95-33-0) and zinc oxide.

The total amount of crosslinkers and vulcanization accelerators in the rubber mixtures is preferably 1.0 to 20 phr, particularly preferably from 2.0 to 13 phr.

### Reinforcing Additives

The rubber mixtures according to the invention may contain one or more reinforcing additives. The rubber mixtures according to the invention preferably contain at least one reinforcing additive from the group of sulfur-containing organic silanes, in particular sulfur-containing silanes containing alkoxysilyl groups and very particularly preferably sulfur-containing organic silanes containing trialkoxysilyl groups.

It is particularly preferable when the rubber mixtures according to the invention contain one or more sulfur-containing silanes from the group of bis(triethoxysilylpropyl)tetrasulfane, bis(triethoxysilylpropyl)disulfane and 3-(triethoxysilyl)-1-propanethiol Liquid sulfur-containing silanes may be absorbed on a carrier (dry liquid) for better meterability and/or dispersibility. The content of sulfur-containing silanes in these “dry liquids” is preferably between 30 and 70 parts by weight, particularly preferably between 40 and 60 parts by weight, per 100 parts by weight of dry liquid.

The rubber mixtures of the invention contain generally 0.1 to 20 phr, preferably 0.5 to 15 phr and more preferably 1.0 to 10 phr of at least one reinforcing additive.

### Rubber Auxiliaries

The rubber mixtures according to the invention may further contain one or more rubber auxiliaries. Examples of suitable rubber auxiliaries include aging stabilizers, bonding agents, heat stabilizers, light stabilizers, flame retardants, processing aids, impact modifiers, plasticizers, tackifiers, blowing agents, dyes, pigments, waxes, extenders, organic acids such as stearic acid, retarders, in particular triethanolamine, polyethylene glycol, hexanetriol, reversion stabilizers and secondary accelerators

These rubber auxiliaries may be added to the rubber mixtures according to the invention in the amounts which are customary for these auxiliaries and are also guided by the end use of the vulcanizates produced therefrom. Customary amounts are, for example, 0.1 to 30 phr.

The rubber mixtures according to the invention may contain one or more aging stabilizers. Suitable aging stabilizers are aminic aging stabilizers, for example diaryl-p-phenylenedianines (DTPD), octylated diphenylamine (ODPA), phenyl-α-naphthylamine (PAN), phenyl-β-naphthylamine (PBN), preferably those based on phenylenediamine, for example N,N′-dicyclohexyl-p-phenylenediamine (CCPD), N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD), N,N′-bis(1,4-dimethylpentyl)-p-phenylenediamine (77PD), and phosphites such as tris(nonylphenyl) phosphite, polymerized 2,2,4-trimethyl-1,2-dihydroquinoline (TMQ), methyl-2-mercaptobenzimidazole (MMBI) and zinc methylmercaptobenzimidazole (ZMMBI) and mixtures thereof. It is particularly preferable when the at least one aging stabilizer is selected from the group consisting of N,N′-dicyclohexyl-p-phenylenediamine (CCPD) and N-1,3-dimethylbutyl-N′-phenyl-p-phenylenediamine (6PPD).

Processing aids should be active between the rubber particles and should counter frictional forces during mixing, plasticizing and forming. Processing aids which may be present in the rubber mixtures according to the invention include all lubricants customary for the processing of plastics, for example hydrocarbons, such as oils, e.g. aromatic process oil, paraffins and PE waxes, fatty alcohols having 6 to 20 carbon atoms, ketones, carboxylic acids, such as fatty acids and montanic acids, oxidized PE wax, aromatically modified cycloaliphatic hydrocarbon resins, metal salts of carboxylic acids, carboxamides and carboxylic esters, for example with the alcohols ethanol, fatty alcohols, glycerol, ethanediol, pentaerythritol and long-chain carboxylic acids as the acid component.

To reduce flammability and to reduce smoke evolution on combustion, the rubber mixtures of the invention may contain flame retardants. Examples of compounds used for this purpose include antimony trioxide, phosphoric esters, chloroparaffin, aluminum hydroxide, boron compounds, zinc compounds with the exception of ZnO, molybdenum trioxide, ferrocene, calcium carbonate or magnesium carbonate.

Further plastics may also be added to the rubber mixtures of the invention prior to the crosslinking, these acting for example as polymeric processing aids or impact modifiers. These plastics are preferably selected from the group consisting of homo- and copolymers based on ethylene, propylene, butadiene, styrene, vinyl acetate, vinyl chloride, glycidyl acrylate, glycidyl methacrylate, acrylates and methacrylates having alcohol components of branched or unbranched C1 to C10 alcohols, particular preference being given to polyacrylates having identical or different alcohol radicals from the group of C4 to C8 alcohols, in particular of butanol, hexanol, octanol and 2-ethylhexanol, polymethylmethacrylate, methyl methacrylate-butyl acrylate copolymers, methyl methacrylate-butyl methacrylate copolymers, ethylene-vinyl acetate copolymers, chlorinated polyethylene, ethylene-propylene copolymers, ethylene-propylene-diene copolymers.

Known bonding agents are based on resorcinol, formaldehyde and silica, the so-called RFS direct bonding systems. These direct bonding systems may be employed in any desired amount of the rubber mixture according to the invention at any time of incorporation into the rubber mixtures according to the invention.

In silica-based rubber mixtures, such as are preferably employed for tire production, diphenylguanidine (DPG) or structurally similar aromatic guanidines are typically employed as secondary accelerators.

A person skilled in the art is aware that DPG may be advantageously substituted by 1,6-bis(N,N-dibenzylthiocarbanoyldithio)hexane which is also known by the trade name Vulcuren®. Substitution of DPG by a secondary accelerator such as TBzTD (tetrabenzylthiuram disulfide) or dithiophosphates is also possible.

The rubber mixtures according to the invention generally contain 0 or from 0.1 to 10 phr, preferably 0.5 to 5 phr, particularly preferably 0.2 to 3.5 phr, of at least one of the secondary accelerators mentioned.

Particular preference is given to rubber mixtures of the invention containing
70 to 100 phr of at least one functionalized synthetic rubber, preferably of a functionalized BR rubber and/or functionalized SBR rubber,
0 to 30 phr of at least one natural rubber and/or unfunctionalized synthetic rubber,
20 to 200 phr of at least one hydroxyl-containing oxidic filler,
0.1 to 120 phr of at least one carbon black, preferably 0.1 to 100 phr,
0.5 to 10 phr of at least one crosslinker, preferably selected from the group of sulfur donors and/or sulfur,
0.1 to 10 phr of zinc oxide,
0.5 to 10 phr of at least one vulcanization accelerator, especially from the group of sulfenamides,
0.1 to 10.0 phr of at least one secondary accelerator,
0.5 to 15 phr of at least one reinforcing additive, especially from the group of sulfur-containing silanes,
0.1 to 30 phr of rubber auxiliaries
and
1 to 15 phr of the at least one ethoxylated compound of formula (I).

The aforementioned further preferred ranges for the individual components also apply to these preferred mixtures.

### Process for Producing the Rubber Mixtures

The present invention further provides a process for producing the rubber mixtures according to the invention, characterized in that the respective components are mixed in a mixing process. This preferably comprises mixing at least one functionalized synthetic rubber, optionally at least one natural rubber and/or unfunctionalized synthetic rubber and at least one ethoxylated compound of formula (I), in the presence of at least one filler, at least one crosslinker, optionally at least one carbon black, optionally at least one vulcanization accelerator, optionally zinc oxide, optionally at least one secondary accelerator, optionally at least one reinforcing additive and optionally one or more of the rubber auxiliaries mentioned with one another in the general and preferred amounts mentioned for these additives at a temperature in the range from 130° C. to 180° C., particularly preferably from 140° C. to 170° C.

The rubber mixtures of the invention are produced in a customary manner in known mixing apparatuses, such as rollers, internal mixers, downstream mixing roller mills and mixing extruders, at shear rates of 1 to 1000 sec⁻¹.

Production of the rubber mixtures according to the invention is preferably carried out in a three-stage mixing process. In a first mixing stage the fillers and the at least one ethoxylated compound of formula (I) and optionally further aforementioned rubber auxiliaries, preferably aging stabilizers and secondary accelerators, are initially incorporated into the rubber in an internal mixer (kneader).

Mixing temperatures in the internal mixer may achieve values up to 180° C. The mixing temperature in the internal mixer is preferably 130° C. to 180° C., particularly preferably 140° C. to 170° C.

This is preferably followed as a second step by so-called post-mastication, preferably at 130-180° C., particularly preferably at 160° C. The post-mastication may be carried out in an internal mixer for example.

In a third mixing stage crosslinkers, vulcanization accelerators and optionally further aforementioned rubber auxiliaries, preferably secondary accelerators and zinc oxide, are added to the mixture obtained from the first mixing stage. The mixing temperature in the second mixing stage is preferably 50-130° C., preferably 55-130° C., in particular from 60° C. to 120° C.

Addition of the at least one ethoxylated compound of formula (I) may be carried out at any time during the mixing, preferably in the first step of the mixing operation at a temperature in the range from 130° C. to 180° C., preferably at a temperature of 140 to 170° C.

The at least one ethoxylated compound of formula (I) may be employed either in pure form or else having been absorbed and/or adsorbed on an inert, organic or inorganic carrier, preferably a carrier selected from the group containing natural or synthetic silicates, in particular neutral, acidic or basic silica, aluminum oxide, carbon black or zinc oxide, in the mixing process.

### Bonding Mixtures

The present invention further provides bonding mixtures containing a rubber mixture according to the invention and at least one bonding agent.

The bonding mixtures according to the invention preferably contain at least one bonding agent based on resorcinol, formaldehyde and silica.

Combinations of resorcinol, formaldehyde and silica are known from the prior art as RFS direct bonding systems. The bonding mixtures of the invention may contain these direct bonding systems in any amount.

The bonding mixtures of the invention may be produced in a known manner by mixing a rubber mixture of the invention with at least one bonding agent based on resorcinol, formaldehyde and silica.

In the bonding agents, formaldehyde may be present in the form of formaldehyde donors. Suitable formaldehyde donors include not only hexamethylenetetramine but also methylolamine derivatives.

In order to improve bonding, one or more components capable of synthetic resin formation, such as phenol and/or amines and/or aldehydes or compounds that eliminate aldehydes, may be added to the bonding mixtures of the invention.

### Process for Producing Rubber Vulcanizates

Process for producing rubber vulcanizates, characterized in that the rubber mixture according to the invention is heated at temperatures of 120° C. to 200° C., preferably at 140° C. to 180° C.

The process for producing the rubber vulcanizates according to the invention may be performed over a wide pressure range, preferably at a pressure in the range from 10 to 200 bar.

The present invention further provides rubber vulcanizates obtainable by vulcanization of the rubber mixtures according to the invention.

The rubber vulcanizates according to the invention have an unexpectedly low rolling resistance, especially when used in tires, coupled with comparable performance characteristics.

In the context of the present invention the rolling resistance is determined via the loss factor tan δ at 60° C. by DIN EN ISO 6721-1 dynamic damping.

### Shaped Articles

The rubber vulcanizates of the invention are suitable for production of all kinds of shaped articles, for example tire components, technical rubber articles such as damping elements, roller coverings, coverings of conveyor belts, drive belts, spinning cops, seals, golfball cores, footwear soles; they are especially suitable for production of tires and tire components, such as tire treads, subtreads, carcasses, sidewalls of tires, reinforced sidewalls for runflat tires, and apex mixtures. Tire treads also include treads of summer, winter and all-season tires and also treads of passenger car, truck and light-truck tires.

Preferred shaped articles are tires and tire parts containing a rubber vulcanizate according to the invention.

### Use

The present invention further provides for the use of the at least one ethoxylated compound of formula (I), in particular in an amount of 0.5 to 20 phr, particularly preferably of 1.0 to 15.0 phr, and of the at least one functionalized synthetic rubber, in particular in an amount of 50-100 phr, particularly preferably of 70-100 phr, for producing vulcanizates having a low rolling resistance made of sulfur-crosslinkable rubber mixtures, at a vulcanization temperature of 120° C. to 200° C.

The present invention further provides for the use of the at least one ethoxylated compound of formula (I) and of the at least one synthetic rubber in rubber mixtures, vulcanizates and shaped articles producible therefrom for reducing the rolling resistance of shaped articles made of rubber vulcanizates, preferably of tires and tire parts.

The descriptions and preferred ranges indicated for the components present and optionally present in the rubber mixture according to the invention, such as the at least one functionalized synthetic rubber, the at least one natural rubber, the at least one unfunctionalized synthetic rubber, the at least one hydroxyl-containing oxidic filler, the at least one carbon black, the at least one crosslinker, the at least one vulcanization accelerator, the zinc oxide, the at least one secondary accelerator, the at least one reinforcing additive, the rubber auxiliaries and the at least one ethoxylated compound of formula (I), apply analogously inter alia for the disclosed processes and uses and the vulcanizates, shaped articles and bonding mixtures.

The indicated descriptions and preferred ranges likewise apply inter alia for the rubber mixtures, vulcanizates, shaped articles, bonding mixtures, processes and uses according to the invention irrespective of whether they were disclosed for the aforementioned in the plural (e.g. rubber mixtures) or in the singular (e.g. rubber mixture).

The invention is to be elucidated by the examples that follow, but without being limited thereto.

### EXEMPLARY EMBODIMENTS

TABLE 1
List of input materials, abbreviations and manufacturers

| Trade name | Description | Manufacturer/distributor |
|---|---|---|
| NIPOL ® BR1261 | Functionalized polybutadiene | Zeon |
| | rubber (BR) | |
| SPRINTAN ® SLR 3402 | Functionalized styrene- | Trinseo |
| | butadiene rubber (SBR) | |
| | (TG −62° C.) | |
| CORAX ® N 234 | Carbon black | Orion Engineered Carbons |
| | | GmbH |
| VIVATEC 500 | Aromatic process oil | Hansen & Rosenthal (H&R |
| | | GRUPPE) |
| PALMERA ® A9818 | Stearic acid | KLK OLEO |
| ANTILUX ® 654 | Wax | Lanxess Deutschland GmbH |
| RHENOGRAN ® CBS-80 | N-Cyclohexyl-2- | Lanxess Deutschland GmbH |
| | benzothiazole-sulfenamide | |
| | (polymer-bound; containing | |
| | 80% CBS) | |
| | Zinc oxide | L. Brüggemann GmbH & Co. |
| | | KG |
| Sulfur | Sulfur | Kandelium Group GmbH |
| VULKANOX ® 4020/LG | N-1,3-dimethylbutyl-N′- | Lanxess Deutschland GmbH |
| | phenyl-p-phenylenediamine | |
| ZEOSIL ® 1165MP | Silica | Solvay Deutschland GmbH |
| VULKANOX ® HS | 2,2,4-trimethyl-1,2- | Lanxess Deutschland GmbH |
| | dihydroquinoline, | |
| | polymerized (TMQ) | |
| SI ® 75 | Bis(triethoxysilylpropyl)tetra- | Evonik Resource Efficiency |
| | sulfane | GmbH |
| RHENOGRAN ® DPG-80 | N,N′-diphenylguanidine | Lanxess Deutschland GmbH |
| | (polymer-bound; containing | |
| | 80% DPG) | |
| MARLIPAL ® O 13/50 | Isotridecanol, ethoxylated | Sasol Germany GmbH |
| | (compound of formula (I), | |
| | where R = iso-C₁₃H₂₇ and x = | |
| | 4-20) | |
| ESCOREZ ® 5600 | Aromatically modified | ExxonMobil |
| | cycloaliphatic hydrocarbon | |
| | resins | |

### Production of the Rubber Vulcanizates

The rubber mixtures of the noninventive reference mixture were produced according to EP2858831A1, which represents a conventional SBR- and BR-containing rubber mixture, and inventive examples 1 and 2 were produced according to the formulations specified in table 2. The difference between the inventive examples and the reference mixture consists in that the latter also contain MARLIPAL® O 13/50 and therefore an ethoxylated compound of formula (I) in addition to the functionalized synthetic rubbers.

Production of the rubber mixtures was carried out in the following steps:

### 1st Mixing Stage:

NIPOL® BR1261 and SPRINTAN® SLR 3402 are initially charged in an internal mixer and mixed for about 30 seconds.
The aging stabilizers VUJLKANOX® 4020 and VULKANOX® HS were added and the mixture was mixed for about 30 seconds.
Half of the ZEOSIL 1165MP and SI® 75 were added and the mixture was mixed for about 60 seconds.
Half of the ZEOSIL 1165MP, CORAX® N 234, and also PALMERA® A9818, Vivatec 500, Escorez 5600, RHENOGRAN® DPG-80 and MARLIPAL® O 13/50 were added and the mixture was mixed for about 60 seconds, then turned. Mixing was carried out until a temperature of 160° C. was reached, then mixing was carried out at 160° C. for 4 minutes.

Upon termination of the first mixing stage the mixed batch was admitted to a downstream roller mill and shaped into a sheet, a strip or pellets and stored at room temperature for 24 hours. Processing temperatures are 70° C.

### 2nd Mixing Stage:

This was followed by mixing in an internal mixer until a temperature of 160° C. was reached (the so-called post-mastication).

Upon termination of the second mixing stage the mixed batch was admitted to a downstream roller mill and shaped into a sheet, a strip or pellets using a roller mill and stored for 24 hours at room temperature.

### 3rd Mixing Stage:

Addition of additives such as sulfur, zinc oxide and Rhenogran®-CBS-80 was carried out in the internal mixer at 100° C. over 2 minutes.

Upon termination of the third mixing stage the mixed batch was shaped into a sheet, a strip or pellets using a roller mill and stored at room temperature for 24 hours. Processing temperatures are in this case 70° C.

The inventive rubber mixtures 1 and 2 showed no speckling on the surface and good mixing of the employed additives is therefore assumed.

TABLE 2
Rubber formulations (data in phr)

| | Reference | Example 1 | Example 2 |
|---|---|---|---|
| NIPOL ® BR1261 | 40 | 40 | 40 |
| SPRINTAN ® SLR | 60 | 60 | 60 |
| 3402 | | | |
| CORAX ® N 234 | 5 | 5 | 5 |
| ZEOSIL ® 1165MP | 120 | 120 | 120 |
| VIVATEC 500 | 20 | 20 | 20 |
| PALMERA ® A9818 | 2 | 2 | 2 |
| VULKANOX ® | 2 | 2 | 2 |
| 4020/LG | | | |
| VULKANOX ® | 2 | 2 | 2 |
| HS/LG | | | |
| RHENOGRAN ® | 2.5 | 2.5 | 2.5 |
| DPG-80 | | | |
| ESCOREZ ® 5600 | 30 | 30 | 30 |
| ANTILUX ® 654 | 2 | 2 | 2 |
| SI ® 75 | 8.5 | 8.5 | 8.5 |
| Zinc oxide WS | 2.5 | 2.5 | 2.5 |
| RHENOGRAN ® | 2 | 2 | 2 |
| CBS-80 | | | |
| Sulfur | 2 | 2 | 2 |
| MARLIPAL ® O | | 5 | 10 |
| 13/50 | | | |

### Technical Testing

The vulcanizates produced at 160° C. from the rubber mixtures of examples 1 and 2 and from the reference mixture were subjected to the technical tests specified below. The determined values are reported in table 3.

Very good properties of the rubber mixtures/their vulcanizates have been achieved when their properties are within the specified “preferred range”.

The tests on test specimens employed the following test methods:

### Mooney Viscosity Measurement

The determination was carried out using a shear disc viscometer according to ASTM D 1646. Viscosity is directly determinable from the opposing force exerted by rubbers (and rubber mixtures) during their processing. In a Mooney shear disc viscomneter a fluted disc is surrounded top and bottom with test substance and moved at about two revolutions per minute in a heatable chamber. The force necessary therefor is measured as torque and corresponds to the respective viscosity. The sample is generally preheated to 100° C. for one minute and measurement lasts a further 4 minutes, the temperature being kept constant. The viscosity is reported together with the respective test conditions, for example ML (1+4) 100° C. (Mooney viscosity, rotor size L, preheating time and test time in minutes, test temperature).

### Employed Rheometer (Vulcameter) and Scorch/Full Vulcanization Time

The MDR (moving die rheometer) vulcanization profile and analytical data associated therewith are measured in an MDR 2000 Monsanto rheometer in accordance with ASTM D5289-95.

The scorch time (5) is the time at which 5% of the rubber is crosslinked. The temperature chosen was 160° C.

The complete vulcanization time (t95) is the time at which 95% of the rubber is crosslinked. The temperature chosen was 160° C.

The value of Delta S′ is calculated from the difference between the highest and the lowest value of the rheometer curve, thus Sₘₐₓ−Sₘᵢₙ.

### Determination of Breaking Elongation, Tensile Strength, 300 Modulus

These measurements were made according to DIN 53504 (tensile test, S2 rod, measured 5 times).

### Determination of Shore—A Hardness

Measurement of Shore hardness (Shore A) according to DIN 53505 at 23° C. (measured 3 times).

### Rebound Elasticity

Measurement of rebound elasticity at 23° C. (measured three times) according to DIN 53512

### Determination of DIN Abrasion

The simplest method for determining abrasive wear is so-called DIN abrasion according to ASTM D5963. The test specimen made of the elastomer to be tested is passed over a specified friction path (40 m) over a test sanding arc on a rotating cylinder at a constant pressing force and at a constant velocity (40 min-1). The material loss in mm³ is subsequently determined.

### Determination of the Loss Factor

The loss factor tan δ was determined at 60° C. and a measuring frequency of 10 Hz by DIN EN ISO 6721-1 dynamic damping.

TABLE 3
Test values

| | | Reference | Example 1 | Example 2 |
|---|---|---|---|---|
| t5 | min | 0.8 | 1.6 | 2.2 |
| t95 | min | 24.5 | 18.4 | 16.0 |
| Delta S′ | dNm | 10.1 | 12.6 | 12.1 |
| MV | MU | 98 | 86 | 77 |
| 300 modulus | MPa | 8.9 | 10.5 | 10.5 |
| Breaking | % | 423 | 457 | 438 |
| elongation | | | | |
| Tensile | MPa | 15.2 | 19.7 | 18.3 |
| strength | | | | |
| Hardness | Shore A | 60 | 58 | 58 |
| Rebound at | % | 39 | 38 | 42 |
| 23° C. | | | | |
| Rebound at | | 53 | 53 | 54 |
| 60° C. | | | | |
| DIN abrasion | mm³ | 129 | 109 | 98 |
| Tan delta | | 0.125 | 0.113 | 0.098 |
| 60° C. | | | | |

### CONCLUSION

It has surprisingly been found that the inventive rubber mixtures according to examples 1 and 2 achieve a shorter complete vulcanization time (t95), longer scorch time (15) and a markedly lower loss factor tan δ at 60° C. and markedly lower DIN abrasion compared to the noninventive rubber mixture reference coupled with unchanged or improved further mechanical properties.

1. A rubber mixture containing
50 to 100 phr of at least one functionalized synthetic rubber,
0 to 50 phr of at least one natural rubber and/or unfunctionalized synthetic rubber,
0.1 to 250 phr of at least one hydroxyl-containing oxidic filler,
0 to 120 phr of at least one carbon black,
0.1 to 20 phr of at least one crosslinker,
and
0.5 to 10 phr of at least one ethoxylated compound of formula (I) 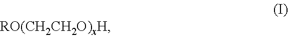
wherein
R represents alkyl, wherein alkyl may be branched or unbranched,
and
x represents a rational number from 1 to 25.

2. The rubber mixture as claimed in claim 1, wherein R represents C₁-C₂₀-alkyl.

3. The rubber mixture as claimed in claim 1, wherein x represents a rational number from 2 to 22.

4. The rubber mixture as claimed in claim 1, wherein the at least one functionalized synthetic rubber is selected from the group consisting of functionalized SBR rubber, functionalized BR rubber and functionalized IR rubber.

5. The rubber mixture as claimed in claim 1, wherein the at least one functionalized synthetic rubber is substituted at the main chain and/or at the end groups by one or more functional groups selected from carboxyl groups, mercaptan groups, alkoxysilane groups, siloxane groups, hydroxyl groups, ethoxy groups, epoxy groups, amino groups, phthalocyanine groups, silane-sulfide groups and metal atom-containing groups.

6. The rubber mixture as claimed in claim 1, wherein the at least one hydroxyl-containing oxidic filler is selected from the group consisting of silicas, synthetic silicates and natural silicates and is present in the rubber mixture in an amount of 0.1 to 250 phr.

7. The rubber mixture as claimed in claim 1, wherein the rubber mixture contains 0.5 to 10 phr of the at least one crosslinker from the group of sulfur and sulfur donors.

8. The rubber mixture as claimed in claim 1, wherein the rubber mixture contains at least one reinforcing additive from the group of sulfur-containing organic silanes.

9. The rubber mixture as claimed in claim 1, wherein the rubber mixture contains
70 to 100 phr of at least one functionalized synthetic rubber,
0 to 30 phr of at least one natural rubber and/or unfunctionalized synthetic rubber,
20 to 200 phr of at least one hydroxyl-containing oxidic filler,
0.1 to 120 phr of at least one carbon black,
0.5 to 10 phr of at least one crosslinker,
0.1 to 10 phr of zinc oxide,
0.5 to 10 phr of at least one vulcanization accelerator,
0.1 to 10.0 phr of at least one secondary accelerator,
0.5 to 15 phr of at least one reinforcing additive,
0.1 to 30 phr of rubber auxiliaries
and
1 to 15 phr of the at least one ethoxylated compound of formula (I).

10. A process for producing the inventive rubber mixtures as claimed in claim 1, wherein the respective components are mixed in a mixing process.

11. A method of producing vulcanizates and rubber shaped articles of all kinds by incorporating the rubber mixtures as claimed in claim 1 into the vulcanizates and rubber shaped articles of all kinds.

12. A vulcanizate obtained by vulcanization of at least one rubber mixture as claimed in claim 1.

13. A vehicle tire, wherein the vehicle tire has at least one vulcanizate as claimed in claim 12.

14. A method of producing vulcanizates incorporating least one ethoxylated compound of formula (I) 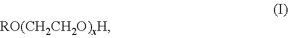
wherein
R represents alkyl, wherein alkyl may be branched or unbranched,
and
x represents a rational number from 1 to 25, in particular in an amount of 0.5 to 20 phr,
and of the at least one functionalized synthetic rubber, in particular in an amount of 50-100 phr,
into the vulcanizates, wherein the vulcanizates have a low rolling resistance from sulfur-crosslinkable rubber mixtures at a vulcanization temperature of 120° C. to 200° C.

15. A bonding mixture comprising at least one rubber mixture as claimed in claim 1 and at least one bonding agent based on resorcinol, formaldehyde and silica.
